(19) United States
(12) Patent Application Publication
(10) Pub. No.: US 2023/0306190 A1
(43) Pub. Date: Sep. 28, 2023

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Atsushi WATANABE, Kanagawa (JP)

(73) Assignee: FUJIFILM Business Innovation Corp., Tokyo (JP)

(21) Appl. No.: 17/875,396

(22) Filed: Jul. 27, 2022

(30) Foreign Application Priority Data
Mar. 28, 2022 (JP) 2022-051246

(51) Int. Cl. G06F 40/166; G06F 16/93; G06F 40/117; G06F 40/197

(52) U.S. Cl. CPC G06F 40/166; G06F 16/93; G06F 40/117; G06F 40/197

(57) ABSTRACT

An information processing system includes: a processor configured to: manage feature information on each feature of one or more objects included in an electronic document including plural pages, for each version of the electronic document; extract a difference in the feature information between versions of the electronic document; and in a case where a user performs an input operation on an image representing the electronic document displayed on a display unit, perform a control of displaying the difference on the display unit in a mode identifiable by the user.

### CROSS-REFERENCE TO RELATED APPLICATIONS

This application is based on and claims priority under 35 USC 119 from Japanese Patent Application No. 2022-051246 filed Mar. 28, 2022.

### BACKGROUND

### (i) Technical Field

The present invention relates to an information processing system, a non-transitory computer readable medium storing a program, and an information processing method.

### (ii) Related Art

A technique is known in which a user can grasp a difference caused by editing an electronic document (for example, JP2009-116674A).

### SUMMARY

With such a technique, it becomes difficult to grasp the difference caused by editing across pages of the electronic document consisting of a plurality of pages.

Aspects of non-limiting embodiments of the present disclosure relate to an information processing system, a non-transitory computer readable medium storing a program, and an information processing method that enable a user to grasp a difference caused by editing across pages of an electronic document, without much difference as compared with a difference caused by editing within the identical page.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: manage feature information on each feature of one or more objects included in an electronic document consisting of a plurality of pages, for each version of the electronic document; extract a difference in the feature information between versions of the electronic document; and in a case where a user performs an input operation on an image representing the electronic document displayed on a display unit, perform a control of displaying the difference on the display unit in a mode identifiable by the user.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system to which the present exemplary embodiment is applied;

FIG. 2 is a diagram illustrating a hardware configuration of a user terminal as an information processing apparatus to which the present exemplary embodiment is applied;

FIG. 3 is a diagram illustrating a functional configuration of a control unit of the user terminal;

FIG. 4 is a diagram illustrating a functional configuration of a control unit of a management server in a case where the management server performs a control or the like of displaying a preview image of each page of an electronic document having two versions in a workspace in a mode in which a difference in feature information of an object can be identified;

FIG. 5 is a flowchart illustrating a flow of a process of the user terminal;

FIG. 6 is a flowchart illustrating the flow of the process of the user terminal;

FIG. 7 is a flowchart illustrating a flow of a process of the management server in a case where the management server performs the control or the like of displaying the preview image of each page of the electronic document having two versions in the workspace in the mode in which the difference in feature information of the object can be identified;

FIG. 8 is a flowchart illustrating the flow of the process of the management server in a case where the management server performs the control or the like of displaying the preview image of each page of the electronic document having two versions in the workspace in the mode in which the difference in feature information of the object can be identified;

FIG. 9 is a diagram illustrating a specific example of the workspace displayed on a display unit of the user terminal;

FIG. 10 is a diagram illustrating another specific example of the workspace displayed on the display unit of the user terminal;

FIG. 11 is a diagram illustrating still another specific example of the workspace displayed on the display unit of the user terminal;

FIG. 12 is a diagram illustrating still another specific example of the workspace displayed on the display unit of the user terminal; and

FIG. 13 is a diagram illustrating still another specific example of the workspace displayed on the display unit of the user terminal.

### DETAILED DESCRIPTION

Hereinafter, exemplary embodiments of the present invention will be described in detail with reference to drawings.

### Configuration of Information Processing System

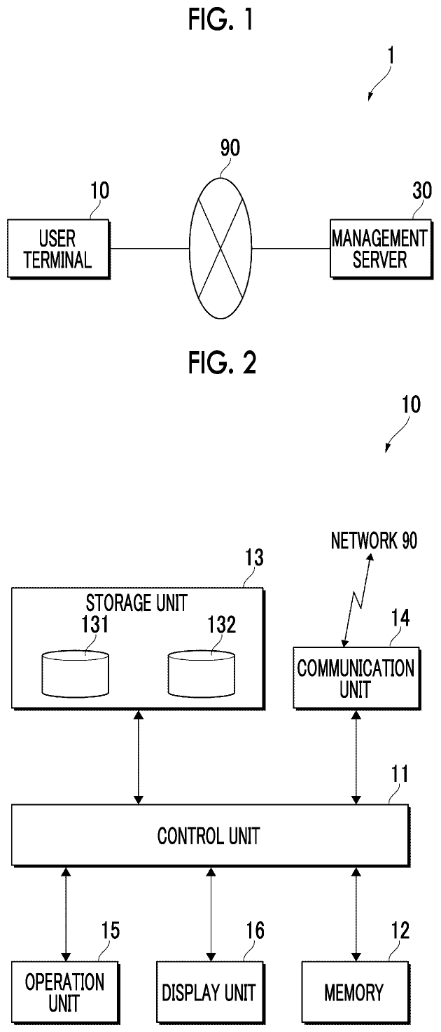

FIG. 1 is a diagram illustrating an example of an overall configuration of an information processing system 1 to which the present exemplary embodiment is applied.

The information processing system 1 is configured by a user terminal 10 and a management server 30 being connected via a network 90. The network 90 is, for example, a local area network (LAN), the Internet, or the like.

The user terminal 10 is an information processing apparatus such as a personal computer, a smartphone, or a tablet terminal operated by a user. The user terminal 10 displays an operation screen (hereinafter, referred to as a “workspace”) on so-called file handling software on a display unit 16 (see FIG. 2), and a thumbnail image representing an electronic document to be handled by the user in the workspace. The thumbnail image of the electronic document displayed in the workspace is a so-called “shortcut”, and the electronic document is stored in a database. In addition, the workspace can be shared with other users via the network 90.

The “electronic document” has a concept of pages, can be edited by an input operation of the user, and is managed by using a “version”. The “version” is a so-called edition version, in which a version number is incremented by one each time the electronic document is saved and closed. A plurality of “workspace”s can be created, and each “workspace” can be displayed on the display unit 16 by an input operation of the user. A type of electronic document is not particularly limited, and includes, for example, a text document created by application software for creating a document and the like.

The user terminal 10 manages information on each feature of one or more objects included in the electronic document (hereinafter, referred to as “feature information”) for each version of the electronic document. The feature information for each version of the electronic document is stored in the database. The “object” means a region of text data, a region of figures, and the like disposed in each location on the page of the electronic document.

In a case where an input operation of selecting a thumbnail image representing an electronic document displayed in a workspace is performed, the user terminal 10 enlarges and displays a preview image of a predetermined page among one or more pages constituting the electronic document in the workspace such that a display size is larger than the thumbnail image representing the electronic document. The “predetermined page” includes, for example, a page at a head of the electronic document, a page most recently opened by the user, and the like. The “predetermined page” may be set individually or collectively by the input operation of the user.

The user terminal 10 accepts an input operation of designating one of one or more objects included in the preview image of the predetermined page of the electronic document of a first version enlarged and displayed in the workspace, and extracts a difference with a second version of feature information of the designated object. The user terminal 10 displays the extracted difference in the workspace in a mode identifiable by the user. Specifically, the user terminal 10 enlarges and displays a preview image of a page including an object of the second version having a difference in feature information from the first version in the workspace in a mode in which the difference can be compared with the preview image of the predetermined page of the electronic document of the first version such that a display size of the preview image is larger than a thumbnail image representing the electronic document.

The “first version” may not mean a “first edition” of the electronic document, and means a predetermined version or a version individually designated by an input operation of the user. Further, the “second version” does not mean the next version of the “first version”, and simply means that the version is different from the “first version”. Therefore, for example, the “first version” may be a “current version” and the “second version” may be the “most recent version of one or more past versions”. Further, the “second version” may be a “version designated by an input operation of a user among one or more past versions”. Details of the above-described process by the user terminal 10 will be described below.

The management server 30 is an information processing apparatus as a server that manages the entire information processing system 1. The management server 30 can perform at least a part of the above-described process by the user terminal 10. That is, the management server 30 can perform a control of displaying a workspace on the display unit 16 of the user terminal 10, and a control of displaying a thumbnail image representing an electronic document in the workspace.

Further, in a case where the user terminal 10 accepts an input operation for a thumbnail image representing an electronic document, the management server 30 can perform a control of enlarging and displaying a preview image of a predetermined page among one or more pages constituting the electronic document in a workspace such that a display size of the preview image is larger than the thumbnail image representing the electronic document. In addition, the management server 30 performs a control of extracting a difference from the past version of feature information of a designated object, in response to an input operation of designating the object included in the preview image of the “predetermined page”, and displaying the extracted difference in the workspace in a mode identifiable by the user. Details of the processes by the management server 30 will be described below.

The configuration of the information processing system 1 described above is an example, and the information processing system 1 as a whole may have a function of realizing the above processes. Therefore, a part or entirety of the function for realizing the process described above may be shared or cooperated in the information processing system 1. That is, as described above, the part or entirety of the function of the user terminal 10 may be a function of the management server 30, or the part or entirety of the function of the management server 30 may be a function of the user terminal 10. Further, a part or entirety of each function of the user terminal 10 and the management server 30 constituting the information processing system 1 may be transferred to another server or the like (not illustrated). Therefore, the processes of the information processing system 1 as an entirety are promoted, and the processes can be complemented with each other.

### Hardware Configuration of User Terminal

FIG. 2 is a diagram illustrating a hardware configuration of the user terminal 10 as an information processing apparatus to which the present exemplary embodiment is applied.

The user terminal 10 includes a control unit 11, a memory 12, a storage unit 13, a communication unit 14, an operation unit 15, and a display unit 16. Each of these units is connected by a data bus, an address bus, a peripheral component interconnect (PCI) bus, or the like.

The control unit 11 is a processor that performs a control of a function of the user terminal 10 through execution of various types of software such as OS (basic software) or application software. The control unit 11 is configured with, for example, a central processing unit (CPU). The memory 12 is a storage region for storing various types of software, data to be used for executing the software, or the like, and is used as a work area for an arithmetic operation. The memory 12 is configured with, for example, a random access memory (RAM) or the like.

The storage unit 13 is a storage region for storing input data to various types of software, output data from various types of software, or the like. The storage unit 13 is configured with, for example, a hard disk drive (HDD), a solid state drive (SSD) , a semiconductor memory, or the like to be used for storing programs, various types of setting data, or the like. As a database for storing various types of information, for example, a document DB 131, which stores one or more electronic documents of which thumbnail images can be displayed in a workspace, an object DB 132, which stores one or more objects included in each of the one or more electronic documents stored in the document DB 131, and the like are stored, in the storage unit 13.

The communication unit 14 transmits and receives data between the management server 30 and an outside via the network 90. The operation unit 15 is configured with, for example, a keyboard, a mouse, a mechanical button, and a switch, and accepts input operations. The operation unit 15 also includes a touch sensor integrally constituting a touch panel with the display unit 16. The display unit 16 is configured with, for example, a liquid crystal display or an organic electro luminescence (=EL) display to be used for displaying information, and displays data of an image or a text and the like. A user interface such as a workspace is displayed on the display unit 16.

### Hardware Configuration of Management Server

Any hardware configuration of the management server 30 has the same configuration as the hardware configuration of the user terminal 10 illustrated in FIG. 2. That is, the management server 30 has each of a control unit, a memory, a storage unit, a communication unit, an operation unit, and a display unit having the same functions as the control unit 11, the memory 12, the storage unit 13, the communication unit 14, the operation unit 15, and the display unit 16 in FIG. 2, and illustration and description thereof will be omitted.

### Functional Configuration of Control Unit of User Terminal

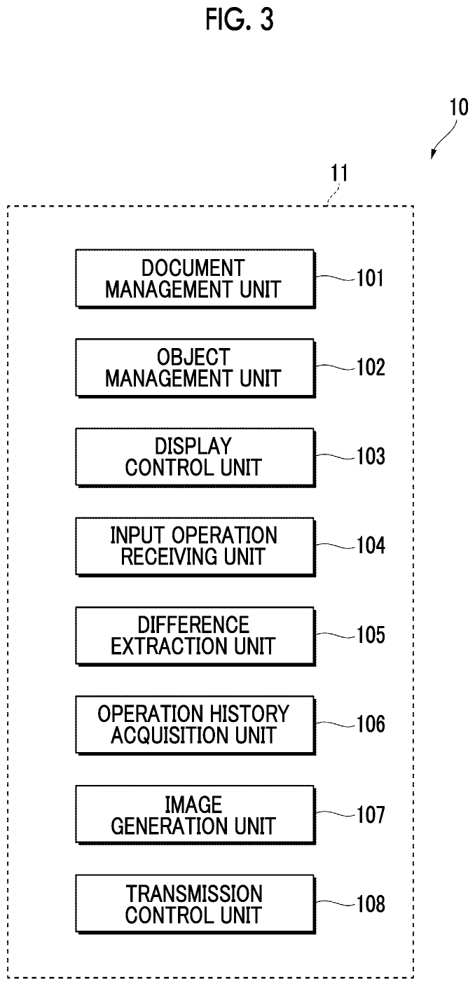

FIG. 3 is a diagram illustrating a functional configuration of the control unit 11 of the user terminal 10.

In the control unit 11 of the user terminal 10, a document management unit 101, an object management unit 102, a display control unit 103, an input operation receiving unit 104, a difference extraction unit 105, an operation history acquisition unit 106, an image generation unit 107, and a transmission control unit 108 function.

The document management unit 101 stores and manages an electronic document in a database. Specifically, the document management unit 101 stores and manages one or more electronic documents of which thumbnail images can be displayed in a workspace in the document DB 131 of the storage unit 13. The one or more electronic documents stored in the document DB 131 include identification information capable of uniquely specifying each document (for example, a document ID or the like) and information on an operation history of each user (hereinafter, referred to as “operation history information”) in association with each other. Of the identification information and the operation history information, the operation history information is associated with information (for example, a user ID or the like) capable of uniquely specifying a user who performs an input operation of opening the electronic document. That is, the document management unit 101 manages which user enlarges and displays a preview image of which page of which version in a workspace at which timing, as a history.

The object management unit 102 stores and manages feature information of one or more objects included in the electronic document in the database. Specifically, the object management unit 102 associates the feature information with information (for example, ID or the like) capable of uniquely specifying each of the one or more objects included in the electronic document configured with one or more pages, and stores the feature information and the information in the object DB 132 of the storage unit 13 and managed the feature information and the information for each version of the electronic document. The feature information of the object is, for example, information indicating a position at which the object is disposed in the entire electronic document, a type of content or font of text data adopted as the object, and a color, a shape, and a size of a figure adopted as the object.

The display control unit 103 performs a control of displaying various types of information on the display unit 16 (see FIG. 2). For example, the display control unit 103 performs a control of displaying the workspace on the display unit 16. The workspace displayed on the display unit 16 can be displayed by starting application software dedicated to the user, which is pre-installed in the user terminal 10, or can be displayed by accessing a website dedicated to the user.

Further, the display control unit 103 performs a control of displaying a thumbnail image of the electronic document designated by the input operation of the user in the workspace. Further, the display control unit 103 performs a control of enlarging and displaying a preview image of a predetermined page among one or more pages constituting the electronic document selected by the input operation of the user in the workspace such that a display size of the preview image is larger than a thumbnail image representing the electronic document.

Further, the display control unit 103 performs a control of displaying a difference between versions of feature information of an object designated by an input operation of a user in the workspace in a mode identifiable by the user. Specifically, as the “mode identifiable by the user”, the display control unit 103 performs a control of enlarging and displaying a preview image of a page including an object of a second version having a difference from a first version in a mode capable of being compared with the preview image of the predetermined page of the electronic document of the first version in the workspace such that the display size of the preview image is larger than the thumbnail image representing the electronic document.

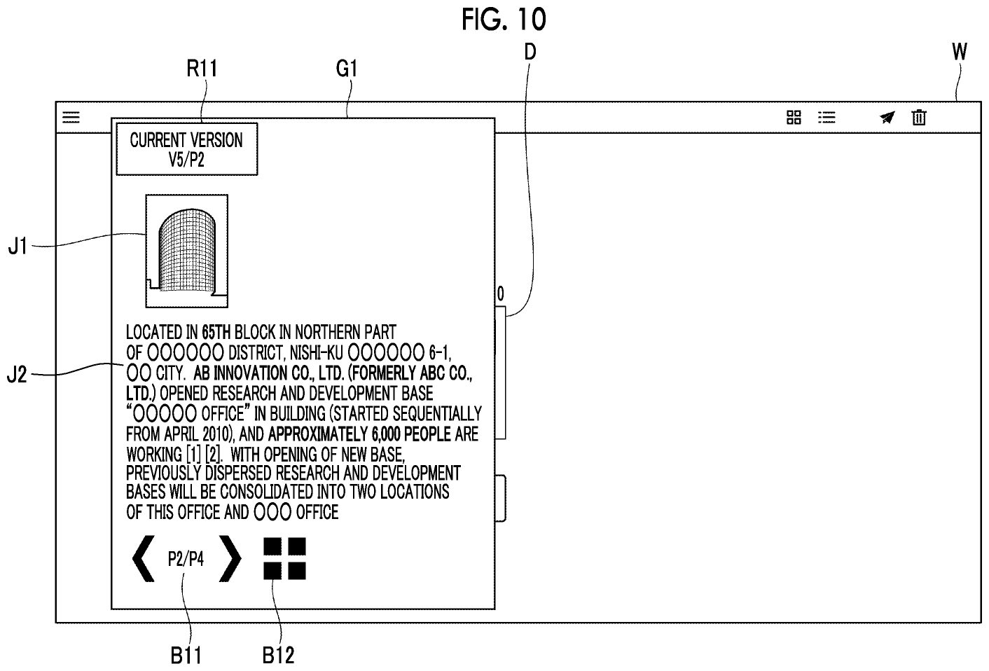

Here, as the “mode capable of being compared”, for example, a mode is used in which the preview image of the page including the object of the first version and the preview image of the page including the object of the second version are disposed side by side, and a difference between the two pieces of feature information is displayed to be highlighted or color-coded. Further, in a case where an input operation of transitioning the preview image of the page of one version (for example, the first version) is performed, a mode is used in which the page of the other version (for example, the second version) is transitioned according to the operation in the same manner. Further, in a case where an input operation of the user is performed in a state in which the display of the preview image of the page of one version (for example, the first version) is fixed, a mode is used in which the version of the preview image of the page of the other version (for example, the second version) is changed. Details of these modes will be described below with reference to specific examples in FIG. 10 and the following.

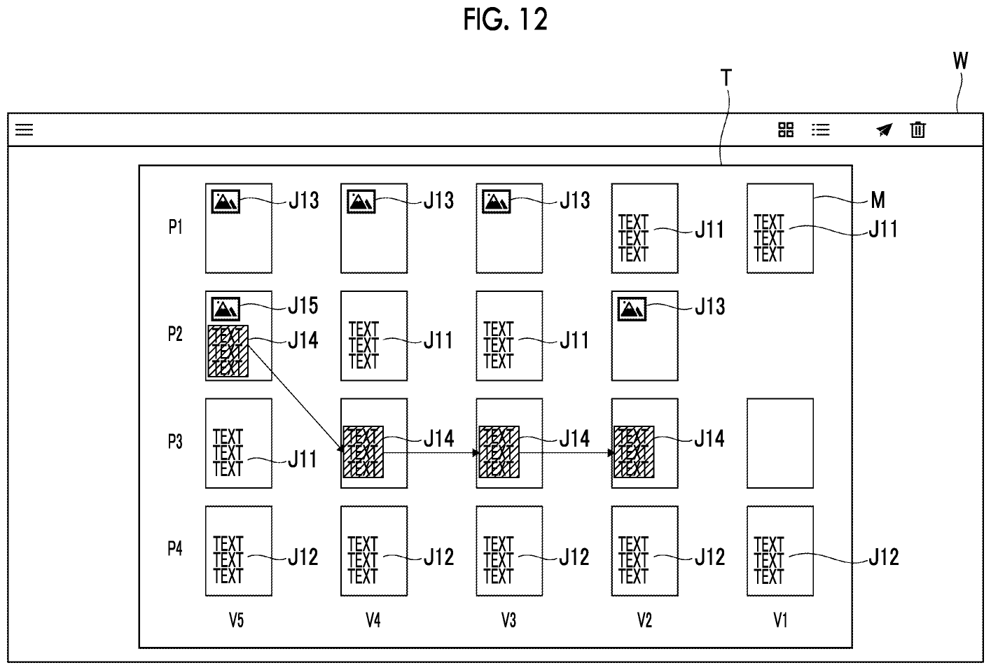

Further, as the “mode identifiable by the user”, the display control unit 103 performs a control of displaying a list image representing a relationship between a plurality of versions of an electronic document and one or more pages constituting the electronic document in the workspace. The “plurality of versions” includes a case of all versions from a first edition to a current version, and a case of a plurality of versions predetermined by an input operation of the user (for example, “from current version to version before 3 versions” or the like). A specific example of the list image representing the relationship between the plurality of versions of the electronic document and the one or more pages constituting the electronic document will be described below with reference to FIG. 12.

The input operation receiving unit 104 accepts an input operation of a user. The input operation of the user includes, for example, a touch operation with a finger and a mouse operation. For example, the input operation receiving unit 104 accepts an input operation of starting application software and displaying a workspace on the display unit 16 (see FIG. 2).

Further, the input operation receiving unit 104 accepts an input operation of designating an electronic document and displaying a thumbnail image in the workspace, or an input operation of selecting the thumbnail image of the electronic document displayed in the workspace. Here, as the “input operation of selecting the thumbnail image of the electronic document”, for example, an operation of superimposing a cursor that moves in the workspace in conjunction with a mouse operation of the user on the thumbnail image of the electronic document (so-called mouse-over operation), an operation of touching or clicking the thumbnail image of the electronic document, and the like are used.

Further, the input operation receiving unit 104 accepts an input operation of designating an object included in the preview image of the page of the electronic document enlarged and displayed in the workspace. Further, the input operation receiving unit 104 accepts an input operation of switching the version of the electronic document of which the preview image of the page including the object is enlarged and displayed in the workspace. For example, the input operation receiving unit 104 accepts an input operation of switching between a plurality of past versions as the second version in a state in which the current version as the first version is fixed. Further, the input operation receiving unit 104 accepts an input operation of switching the page of the electronic document enlarged and displayed as the preview image in the workspace.

The difference extraction unit 105 extracts a difference in feature information of the object designated by the input operation of the user. Specifically, the difference extraction unit 105 extracts a difference between the feature information of the designated object, included in the electronic document of the first version enlarged and displayed in the workspace and the feature information of the designated object, included in the electronic document of the second version. For example, the difference extraction unit 105 extracts each difference between the feature information of the designated object, included in the electronic document of the current version as the first version and the feature information of the designated object, included in each of a plurality of past electronic documents as the second version.

The operation history acquisition unit 106 acquires operation history information of the electronic image. Specifically, the operation history acquisition unit 106 acquires the operation history information of the electronic image of which the thumbnail image is displayed in the workspace, among one or more electronic documents stored in the document DB 131 of the storage unit 13. The operation history information includes information capable of specifying a page displayed on the display unit 16 immediately before the electronic document is closed, information capable of specifying a page edited immediately before the electronic document is closed, among one or more pages constituting the electronic document, and the like, and these pieces of information are associated with the information capable of uniquely identifying the user.

The image generation unit 107 generates a list image representing a relationship between a plurality of versions of an electronic document and one or more pages constituting the electronic document. The list image generated by the image generation unit 107 is displayed in the workspace based on an input operation of the user. This list image is an image in which a thumbnail image of each of the one or more pages constituting the electronic document is disposed in a mode in which the thumbnail images can be viewed in a list for each version.

In the thumbnail image of each page included in the list image, one or more objects are displayed in a selectable mode. In a case where the user performs an operation of designating one object among the one or more objects displayed in the thumbnail image of the page, the object display mode is changed to a mode in which the one object is identified from the other objects, in all the versions having the object. For example, the object may be displayed to be highlighted or a color of the object may be changed.

The transmission control unit 108 performs a control of transmitting various types of information to the management server 30 or an outside via the communication unit 14 (see FIG. 2). For example, in a case where the management server 30 performs one or more of a control of displaying the workspace on the display unit 16 of the user terminal 10, a control of displaying the thumbnail image of the electronic document in the workspace, and a control of displaying a preview image of each page of the electronic document of two versions in the workspace in a mode in which a difference in feature information of the object can be identified, the transmission control unit 108 performs a control of transmitting various types of input information to the management server 30 in a case where the input operation receiving unit 104 accepts an input.

### Functional Configuration of Control Unit of Management Server

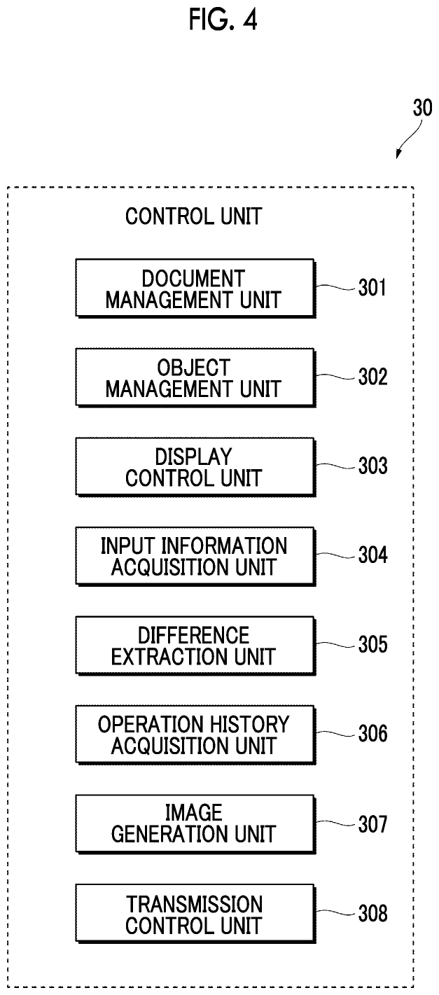

FIG. 4 is a diagram illustrating a functional configuration of a control unit of the management server 30 in a case where the management server 30 performs a control or the like of displaying a preview image of each page of an electronic document having two versions in a workspace in a mode in which a difference in feature information of an object can be identified.

In a case where the management server 30 performs these processes, in the control unit of the management server 30, a document management unit 301, an object management unit 302, a display control unit 303, an input information acquisition unit 304, a difference extraction unit 305, an operation history acquisition unit 306, an image generation unit 307, and a transmission control unit 308 function. Among these units, each function of the document management unit 301, the object management unit 302, the display control unit 303, the difference extraction unit 305, the operation history acquisition unit 306, and the image generation unit 307 has the same manner as each function of the document management unit 101, the object management unit 102, the display control unit 103, the difference extraction unit 105, the operation history acquisition unit 106, and the image generation unit 107 in FIG. 3, and description thereof will be omitted.

The input information acquisition unit 304 acquires various types of input information transmitted from the user terminal 10. For example, the input information acquisition unit 304 acquires input information input for displaying an electronic document stored and managed in a database in the storage unit of the management server 30 in a workspace.

Further, for example, the input information acquisition unit 304 acquires input information input for selecting a preview image of the electronic document displayed in the workspace. Further, for example, the input information acquisition unit 304 acquires input information input for designating an object included in the preview image of a page of the electronic document enlarged and displayed in the workspace. Further, the input information acquisition unit 304 acquires input information input for switching a version of the electronic document of which the preview image of the page is enlarged and displayed in the workspace. Further, the input information acquisition unit 304 acquires input information input for switching the page of the electronic document enlarged and displayed as the preview image in the workspace.

The transmission control unit 308 performs a control of transmitting various types of information to the user terminal 10 or the outside via the communication unit. Further, the transmission control unit 308 performs a control of transmitting information on an electronic document designated by an input operation of a user to the user terminal 10, among one or more electronic documents stored and managed in the database stored in the storage unit. For example, as the “information on the electronic document” the transmission control unit 308 performs a control of transmitting information such as data of a thumbnail image of the electronic document, data of the preview image of all pages for each version of the electronic document, and data of a difference in feature information for each object extracted by the difference extraction unit 305, to the user terminal 10.

### Flow of Process of User Terminal

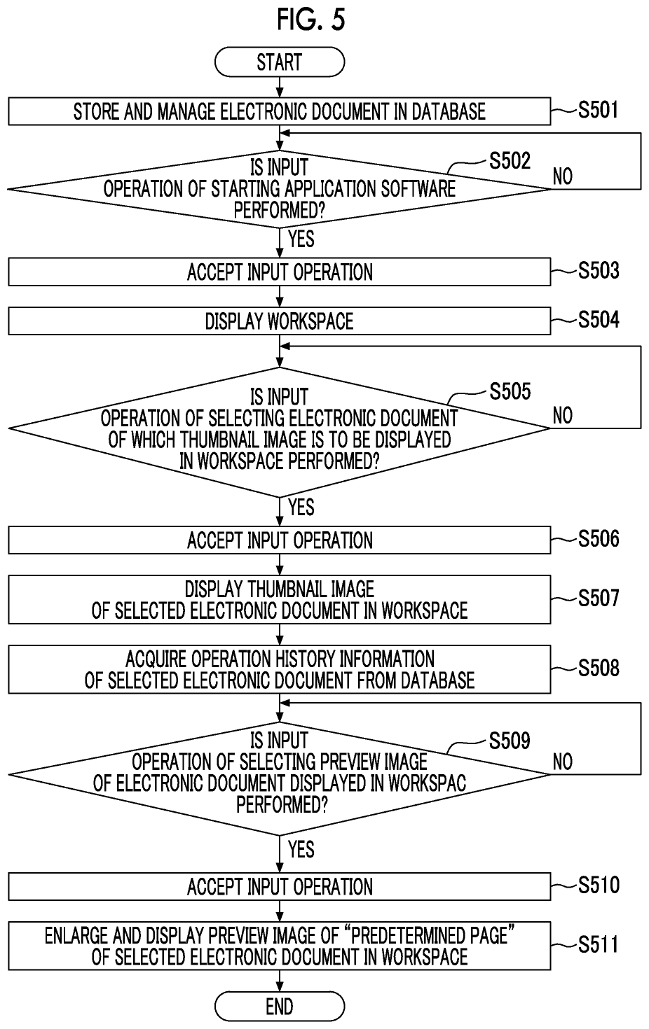

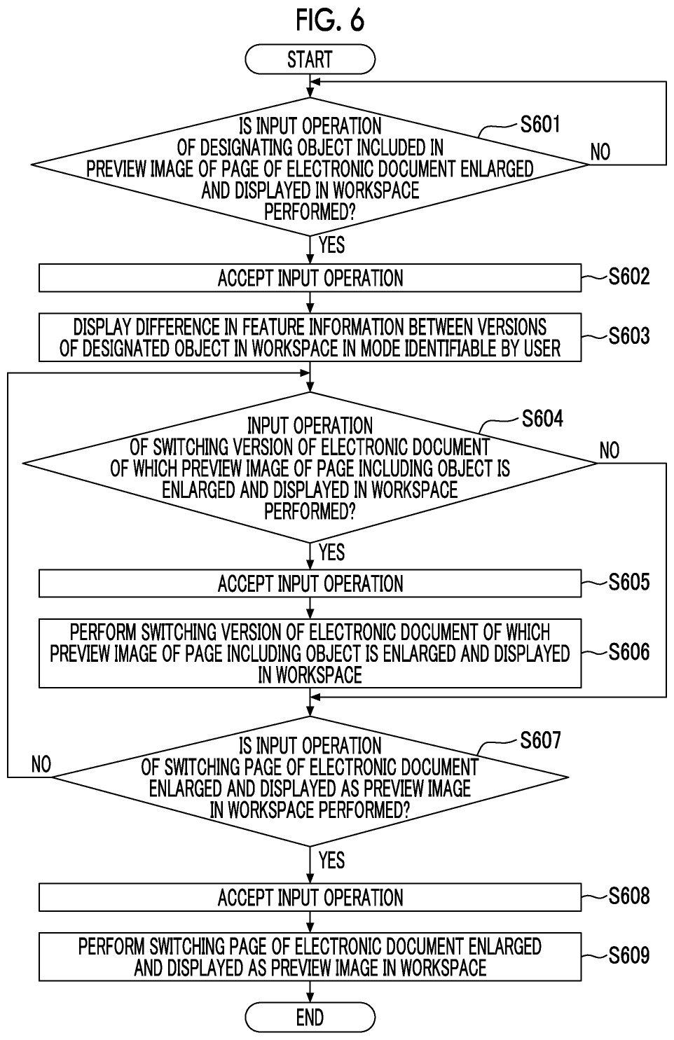

FIGS. 5 and 6 are flowcharts illustrating a flow of a process of the user terminal 10.

In FIG. 5, among the flows of the process of the user terminal 10, a flow from a process of managing an electronic document in a database to a process of enlarging and displaying the “predetermined page” of the selected electronic document in a workspace is illustrated.

The user terminal 10 stores and manages the electronic document in the database (step S501). Specifically, the user terminal 10 stores and manages one or more electronic documents that can be displayed in the workspace in the document DB 131 of the storage unit 13 (see FIG. 2).

In a case where an input operation of starting application software is performed (YES in step S502), the user terminal 10 accepts the input operation (step S503), and displays the workspace on the display unit 16 (see FIG. 2) (step S504). On the other hand, in a case where the input operation of starting the application software is not performed (NO in step S502), the user terminal 10 repeats step S502 until the input operation of starting the application software is performed.

In a case where an input operation of selecting an electronic document of which a thumbnail image is to be displayed in the workspace is performed (YES in step S505), the user terminal 10 accepts the input operation (step S506), and displays the thumbnail image of the selected electronic document in the workspace (step S507). Further, the user terminal 10 acquires operation history information of the selected electronic document from the database (step S508). On the other hand, in a case where the input operation of selecting the electronic document of which the thumbnail image is to be displayed in the workspace is not performed (NO in step S505), the user terminal 10 repeats step S505 until the input operation of selecting the electronic document of which the thumbnail image is to be displayed in the workspace is performed.

In a case where an input operation of selecting a preview image of an electronic document displayed in the workspace is performed (YES in step S509), the user terminal 10 accepts the input operation (step S510), and enlarges and displays the preview image of a “predetermined page” of the selected electronic document in the workspace (step S511). On the other hand, in a case where the input operation of selecting the preview image of the electronic document displayed in the workspace is not performed (NO in step S509), the user terminal 10 repeats step S509 until the input operation of selecting the preview image of the electronic document displayed in the workspace is performed.

In FIG. 6, among the flows of the process of the user terminal 10, a flow from a process of accepting an input operation of designating an object included in a preview image of a page of an electronic document enlarged and displayed in a workspace to a process of switching the page of the electronic document enlarged and displayed as the preview image in the workspace is illustrated.

In a case where an input operation of designating an object included in a preview image of a page of an electronic document enlarged and displayed in a workspace is performed (YES in step S601), the user terminal 10 accepts the input operation (step S602), and displays a difference in feature information between versions of the designated object in the workspace in a mode identifiable by a user (step S603).

On the other hand, in a case where the input operation of designating the object included in the preview image of the page of the electronic document enlarged and displayed in the workspace is not performed (NO in step S601), the user terminal 10 repeats step S601 until the input operation of designating the object included in the preview image of the page of the electronic document enlarged and displayed in the workspace is performed.

In a case where an input operation of switching the version of the electronic document of which the preview image of the page including the object is enlarged and displayed in the workspace is performed (YES in step S604), the user terminal 10 accepts the input operation (step S605), and performs a switching the version of the electronic document of which the preview image of the page including the object is enlarged and displayed in the workspace (step S606). On the other hand, in a case where the input operation of switching the version of the electronic document for which the preview image of the page including the object is enlarged and displayed in the workspace is not performed (NO in step S604), the process proceeds to step 5607.

In a case where an input operation of switching the page of the electronic document enlarged and displayed as the preview image in the workspace is performed (YES in step S607), the user terminal 10 accepts the input operation (step S608), and performs a switching the page of the electronic document enlarged and displayed as the preview image in the workspace (step S609). On the other hand, in a case where the input operation of switching the page of the electronic document enlarged and displayed as the preview image in the workspace is not performed (NO in step S607), the process returns to step S604.

### Flow of Process of Management Server

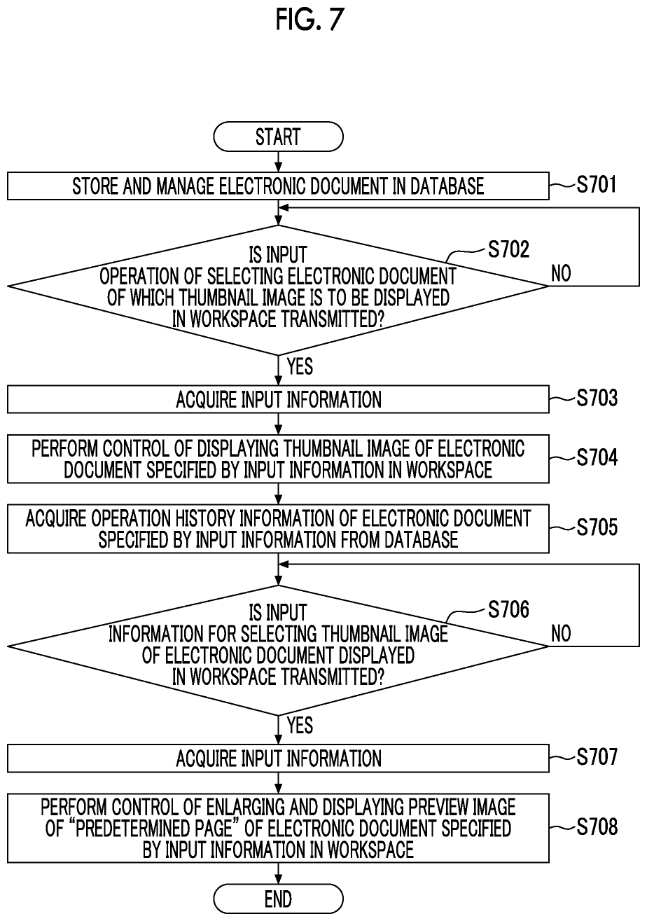

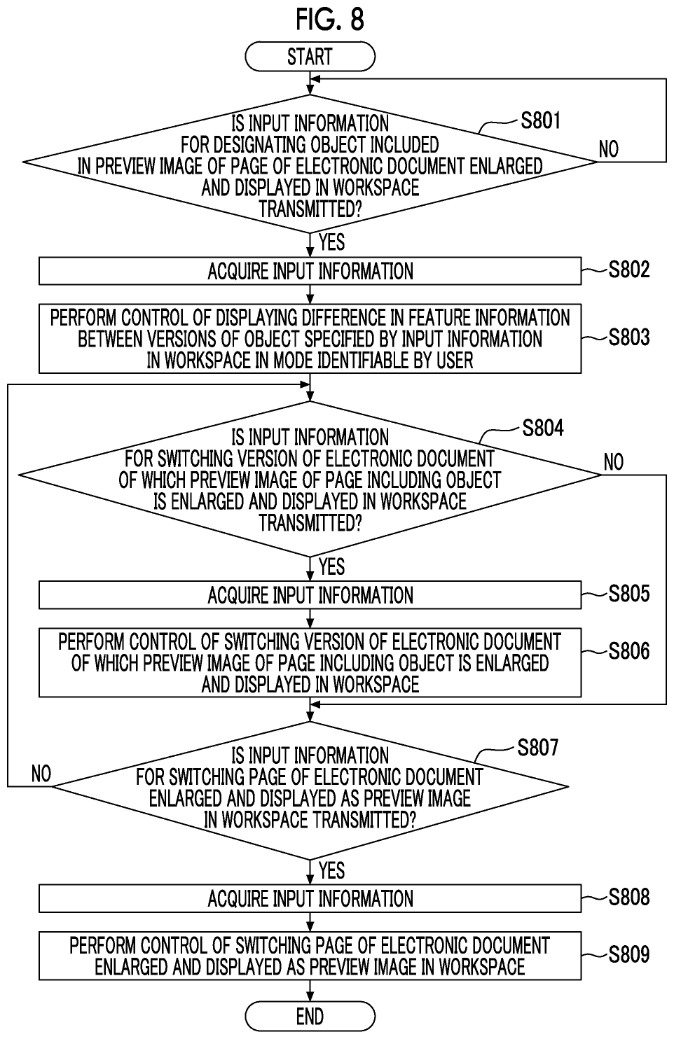

FIGS. 7 and 8 are flowcharts illustrating a flow of a process of the management server 30 in a case where the management server 30 performs a control or the like of displaying a preview image of each page of an electronic document having two versions in a workspace in a mode in which a difference in feature information of an object can be identified.

In FIG. 7, among the flows of the process of the management server 30, a flow from a process of managing an electronic document in a database to a process of performing a control of enlarging and displaying a “predetermined page” of the selected electronic document in a workspace is illustrated.

The management server 30 stores and manages the electronic document in the database (step S701). In a case where input information input to the user terminal 10 by an input operation of a user, for selecting an electronic document of which a thumbnail image is to be displayed in the workspace is transmitted (YES in step S702), the management server 30 acquires the input information (step S703), and performs a control of displaying the thumbnail image of the electronic document specified by the input information in the workspace (step S704). Further, the management server 30 acquires operation history information of the electronic document specified by the input information from the database (step S705). On the other hand, in a case where the input information for selecting the electronic document of which the thumbnail image is to be displayed in the workspace is not transmitted (NO in step S702), the management server 30 repeats step S702 until the input information for selecting the electronic document of which the thumbnail image is to be displayed in the workspace is transmitted.

In a case where input information input to the user terminal 10 by an input operation of the user, for selecting a thumbnail image of the electronic document displayed in the workspace is transmitted (YES in step S706), the management server 30 acquires the input information (step S707), and performs a control of enlarging and displaying a preview image of a “predetermined page” of the electronic document specified by the input information in the workspace (step S708). On the other hand, in a case where the input information for selecting the thumbnail image of the electronic document displayed in the workspace is not transmitted (NO in step S706), the management server 30 repeats step S706 until the input information for selecting the thumbnail image of the electronic document displayed in the workspace is transmitted.

In FIG. 8, among the flows of the process of the management server 30, a flow from a process of acquiring input information input for designating an object included in a preview image of a page of an electronic document enlarged and displayed in a workspace to a process of performing a control of switching the page of the electronic document enlarged and displayed as the preview image in the workspace is illustrated.

In a case where input information input to the user terminal 10 by an input operation of a user, for designating an object included in a preview image of a page of an electronic document enlarged and displayed in a workspace is transmitted (YES in step S801), the management server 30 acquires the input information (step S802), and performs a control of displaying a difference in feature information between versions of the object specified by the input information in the workspace in a mode identifiable by the user (step S803). On the other hand, in a case where the input information for designating the object included in the preview image of the page of the electronic document enlarged and displayed in the workspace is not transmitted (NO in step S801), the management server 30 repeats step S801 until the input information is transmitted.

In a case where input information input to the user terminal 10 by an input operation of the user, for switching the version of the electronic document of which the preview image of the page including the object is enlarged and displayed in the workspace is transmitted (YES in step S804), the management server 30 acquires the input information (step S805), and performs a control of switching the version of the electronic document of which the preview image of the page including the object is enlarged and displayed in the workspace based on the acquired input information (step S806). On the other hand, in a case where the input information for switching the version of the electronic document for which the preview image of the page including the object is enlarged and displayed in the workspace is not transmitted (NO in step S804), the process proceeds to step S807.

In a case where input information input to the user terminal 10 by an input operation of the user, for switching the page of the electronic document enlarged and displayed as the preview image in the workspace is transmitted (YES in step S807), the management server 30 acquires the input information (step S808), and performs a control of switching the page of the electronic document enlarged and displayed as the preview image in the workspace based on the acquired input information (step S809). On the other hand, in a case where the input information for switching the page of the electronic document enlarged and displayed as the preview image in the workspace is not transmitted (NO in step S807), the process returns to step S804.

### SPECIFIC EXAMPLE

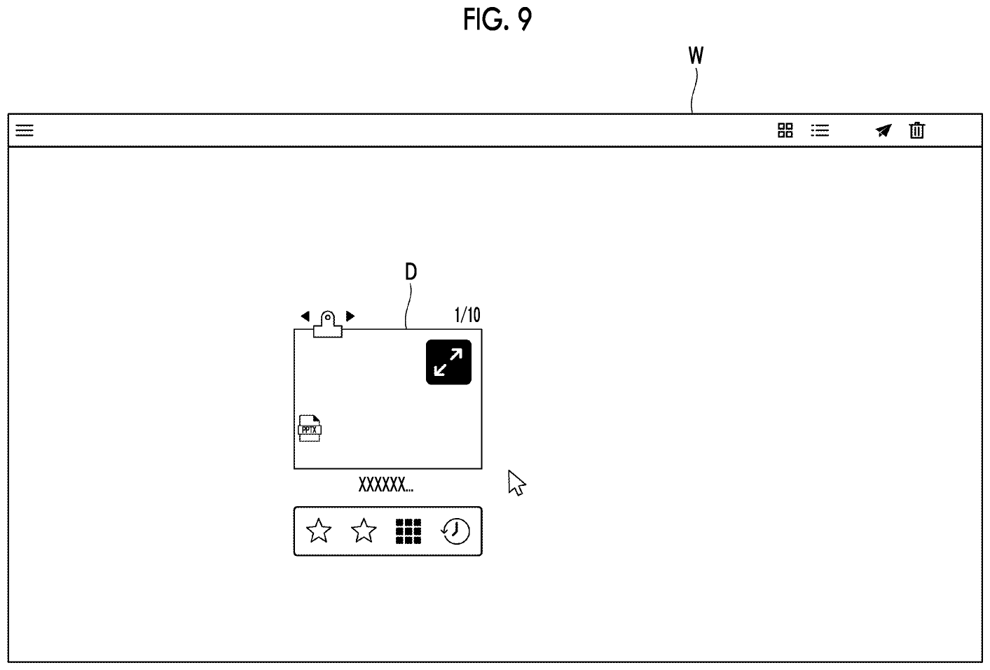

FIGS. 9 to 13 are diagrams illustrating specific examples of a workspace displayed on the display unit 16 of the user terminal 10.

As described above, in a case where an input operation of selecting a thumbnail image representing an electronic document displayed in a workspace is performed, a preview image of a predetermined page among one or more pages constituting the electronic document is enlarged and displayed in the workspace such that a display size is larger than the thumbnail image representing the electronic document. FIG. 9 illustrates the state of a workspace W before an input operation of selecting a thumbnail image D representing an electronic document is performed.

FIG. 10 illustrates a specific example of a preview image of a “predetermined page” enlarged and displayed in the workspace W by performing the input operation of selecting the thumbnail image D representing the electronic document. In the following description, the preview image of the “predetermined page” enlarged and displayed in the workspace W is referred to as a “quick view”. Further, in the example in FIG. 10, it is preset that the “predetermined page” is a page most recently opened by a user.

In a case where the user performs the input operation of selecting the thumbnail image D representing the electronic document, as illustrated in FIG. 10, among one or more pages constituting the current version of the electronic document, a preview image G1 of the page most recently opened by the user is enlarged and displayed in the workspace W, as the quick view. In the preview image G1, an object J1 and an object J2 are displayed as information displayed on an actual page. The object J1 is image data obtained by capturing an image of a building, and the object J2 is text data.

Further, in the preview image G1, in addition to the information indicated on the actual page, an information display region R11 and buttons B11 and B12 are displayed as user interfaces. Among the information display region R11 and the buttons B11 and B12, the information display region R11 is a region in which information on the preview image G1 is displayed. In the example in FIG. 10, as the information on the preview image G1, a notation indicating the current version, a current version (version) number (V5), and a displayed page number (P2) are displayed. Further, the button B11 is a button for switching the displayed page. The displayed page number and a total number of pages constituting the electronic document are indicated on the button B11. In the example in FIG. 10, it is indicated that the displayed page number is “2” (P2) and the total number of pages constituting the electronic document is “4” (P4). The button B12 is a button for displaying a list image in the workspace W. A specific example of the list image displayed in a case where the button B12 is pressed will be described below with reference to FIG. 12.

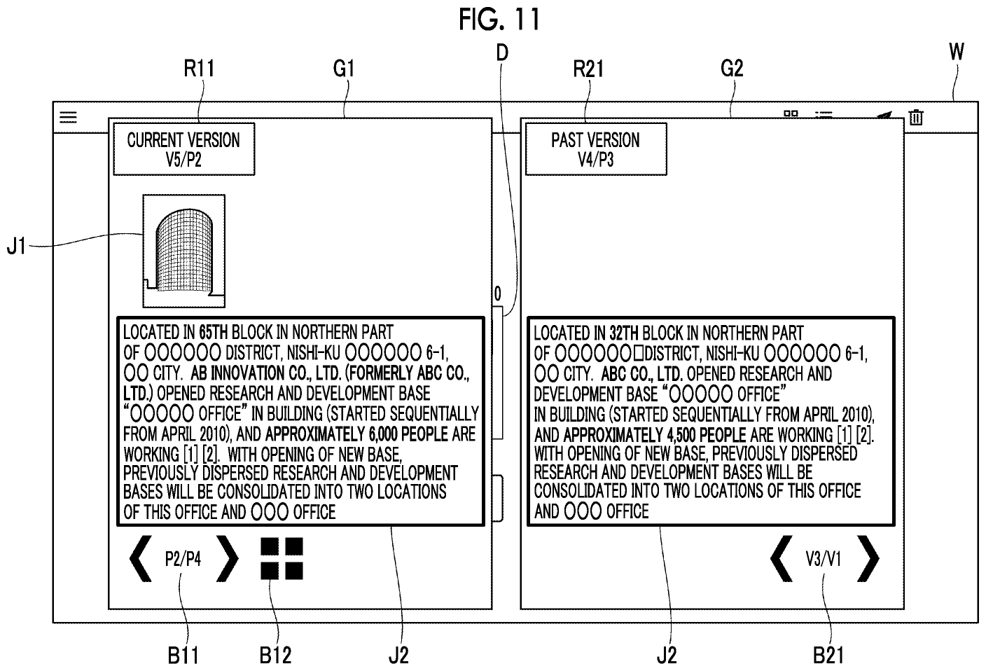

In a case where the user performs an operation of selecting, for example, the object J2 in a state in which the preview image G1 is displayed as the quick view, the most recent past version of the object J2 is displayed. At the same time, a difference between the current version and the past version of the object J2 is displayed in an identifiable mode. In the example in FIG. 11, as a past version, a preview image G2 of a page (P3) including the object J2 is displayed, among one or more pages constituting an electronic document of a previous version (V4). In the preview image G2, the object J2 is displayed as information displayed on an actual page. In the object J2, a difference between the current version and the past version is displayed in bold. In the example in FIG. 11, there is the difference between the current version and the past version of the object J2, and in a case where there is no difference, a message that there is no difference is displayed.

In the preview image G2, in addition to the information displayed on the actual page, an information display region R21 and a button B21 are displayed as user interfaces. Of the information display region R21 and the button B21, the information display region R21 is a region in which information on the preview image G2 is displayed. In the example in FIG. 11, as the information on the preview image G2, a notation indicating a past version, a displayed version (version) number (V4), and a displayed page number (P3) are displayed. Further, the button B21 is a button for switching the displayed version. In the button B21, the number of a version switched when pressed is indicated. The example in FIG. 11 indicates that in a case where a button on the left side of the button B21 is pressed, the current version is switched to a version before 2 versions (V3), and in a case where a button on the right side of the button B21 is pressed, the version is switched to a first edition (V1).

In the example in FIG. 11, the preview image G1 and the preview image G2 fit in a display region of the workspace W, and may not fit in the display region of the workspace W, such as in a case of being enlarged and displayed. In this case, in a case where a preview image of one version (for example, the preview image G1) is transitioned by an input operation of the user, a page of the other version (for example, the preview image G2) is accordingly transitioned in the same manner.

In a case where the button B12 displayed in the quick view is pressed, a list image T as illustrated in FIG. 12, for example, is displayed in the workspace W. In the list image T, a relationship between a plurality of versions of the electronic document and one or more pages constituting the electronic document is illustrated by thumbnail images M of a plurality of pages. With the list image T illustrated in FIG. 12, it may be grasped at a glance that a current version number of the electronic document is “V5” and a total number of pages of the electronic document is “P4”. In addition, a change history of a position of an object may be checked across the pages.

For example, in a case where a current version of an object J14 displayed in the list image T is selected by an input operation of the user, the object J14 included in the thumbnail image M is highlighted for each version. Therefore, the user may grasp at a glance that the object J14 is included in a second page of the current version (V5), a third page of the previous version (V4), a third page of the version before 2 versions (V3), and a third page of a version before 3 versions (V2) and a position on the page at which the object J14 is disposed.

From the list image T illustrated in FIG. 12, in addition to the information described above, for example, it is possible to check that an object J11 as text data is disposed in the first page (V1), the first page (V2), the second page (V3), the second page (V4), and the third page (V5), from the first edition (V1) to the current version (V5), that is, a history of a change in position. Further, for example, it is possible to check that an object J13 as image data is disposed in the second page (V2), the first page (V3), the first page (V4), and the first page (V5), that is, a history of a change in position.

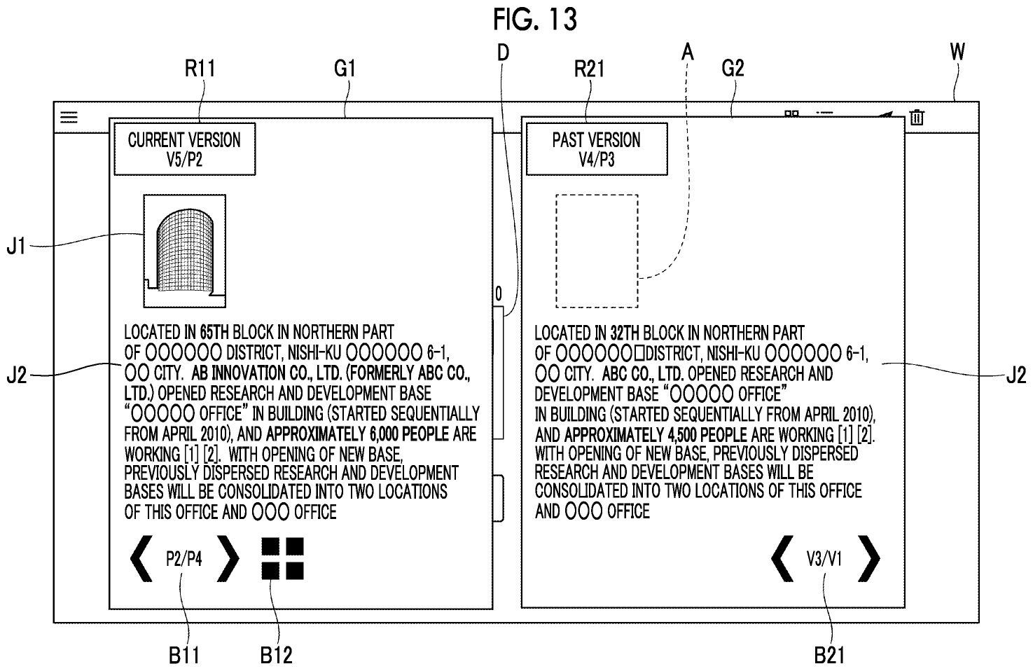

FIG. 13 illustrates an example of a case where a file format of an electronic document selected by an input operation of a user is a portable document format (PDF). In a case where the file format of the selected electronic document is the PDF format, a difference in feature information is extracted not in an object unit but in a page unit. In this case, the feature information to be extracted includes, for example, the presence or absence of a figure, a position of the figure, contents of a document, and the like.

In a case where an operation of selecting a thumbnail image representing the electronic document in the PDF format displayed in the workspace W is performed, as illustrated in FIG. 13, a quick view of the current version and a quick view of the most recent version among the past versions in which a difference is generated in feature information are displayed in a mode capable of being compared. For example, as illustrated in FIG. 13, a region A of a broken line indicates that the object J1 existing in the current version (V5) does not exist in the most recent past version (V4) in which a difference is generated. Further, in the same manner as in FIG. 11 described above, a difference between the objects J2 is displayed in bold.

Although the present exemplary embodiment is described above, the exemplary embodiment of the present invention is not limited to the present exemplary embodiment. Further, the effect of the exemplary embodiment of the present invention is not limited to the present exemplary embodiment. For example, any of the configuration of the information processing system 1 illustrated in FIG. 1 and the hardware configuration of the user terminal 10 illustrated in FIG. 2 is merely an example for achieving the object of the exemplary embodiment of the present invention, and is not particularly limited. Further, the functional configuration of the user terminal 10 illustrated in FIG. 3 and the functional configuration of the management server 30 illustrated in FIG. 4 are merely examples, and are not particularly limited. As long as the information processing system 1 in FIG. 1 is provided with a function capable of executing the processes described above as an entirety, a functional configuration to be used to realize this function is not limited to the examples in FIGS. 3 and 4.

Further, the order of each of the processing steps of the user terminal 10 illustrated in FIGS. 5 and 6 and the processing steps of the management server 30 illustrated in FIGS. 7 and 8 is merely an example, and is not particularly limited. Not only the processes performed in chronological order according to the order of the illustrated steps, but also the processes may not necessarily be performed in chronological order, and may be performed in parallel or individually. Further, the specific examples illustrated in FIGS. 9 to 13 are merely examples, and are not particularly limited.

For example, in the example in FIG. 11, the difference between the objects J2 is emphasized by displaying the difference in bold, and the exemplary embodiment is not limited thereto. As long as the mode can be identified by the user at a glance, for example, a text data portion of the difference may be surrounded by a frame or display to be highlighted. Further, for example, by hiding the text data other than the difference, only the difference text data may be displayed.

Further, for example, in the example in FIG. 12, the change history of the position of the object J14 is highlight-displayed by highlighting, and the exemplary embodiment is not limited thereto. For example, the object J14 may be surrounded by a thick frame, or the text data of the object J14 may be displayed in bold, as long as the mode can be identified by the user at a glance. Further, for example, by hiding other pages that do not include the object J14, only the change history of the position of the object J14 may be displayed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
manage feature information on each feature of one or more objects included in an electronic document consisting of a plurality of pages, for each version of the electronic document;
extract a difference in the feature information between versions of the electronic document; and
in a case where a user performs an input operation on an image representing the electronic document displayed on a display unit, perform a control of displaying the difference on the display unit in a mode identifiable by the user.

2. The information processing system according to claim 1, wherein the processor is configured to:
manage the feature information including at least information indicating a position of the object in the electronic document, for each version of the electronic document.

3. The information processing system according to claim 2, wherein the processor is configured to:
manage the feature information including at least information capable of specifying each of a page to which the object belongs and a disposition position of the object in the page as the information indicating the position, for each version of the electronic document.

4. The information processing system according to claim 3, wherein the processor is configured to:
as the control of displaying the difference on the display unit in the mode identifiable by the user, perform a control of displaying a list image representing a relationship between a plurality of versions and the plurality of pages of the electronic document on the display unit.

5. The information processing system according to claim 4, wherein the processor is configured to:
in a case where an input operation of designating the object included in the list image is performed, perform a control of highlighting a display position of the designated object for each version.

6. The information processing system according to claim 1, wherein the processor is configured to:
perform a control of displaying a difference between the feature information of a first version and the feature information of a second version of the electronic document designated by the user on the display unit in the mode identifiable by the user.

7. The information processing system according to claim 6, wherein the processor is configured to:
perform a control of displaying a difference between the feature information of a current version as the first version, which is designated in advance by the user, and the feature information of the second version, which is sequentially designated by the user, on the display unit in the mode identifiable by the user.

8. The information processing system according to claim 1, wherein the processor is configured to:
in a case where as the input operation, an operation of selecting a thumbnail image of the electronic document is performed on the image representing the electronic document, perform a control of displaying the difference on the display unit in the mode identifiable by the user.

9. The information processing system according to claim 8, wherein the processor is configured to:
in a case where as the operation of selecting the thumbnail image, an operation of superimposing a cursor that moves in the display unit in conjunction with the input operation of the user on the thumbnail image is performed, perform a control of displaying the difference on the display unit in the mode identifiable by the user.

10. The information processing system according to claim 9, wherein the processor is configured to:
as the mode identifiable by the user, perform a control of enlarging and displaying a preview image of each page of a version, in which the difference is generated, of the electronic document on the display unit such that a display size of the preview image is larger than a display size of the thumbnail image.

11. The information processing system according to claim 10, wherein the processor is configured to:
perform a control of enlarging and displaying the preview image side by side on the display unit, and
in response to an input operation of transitioning one page by the user, perform a control of transitioning the other page in the same manner.

12. The information processing system according to claim 10, wherein the processor is configured to:
perform a control of enlarging and displaying the preview image side by side on the display unit, and
in response to the input operation by the user, perform a control of changing one version of the electronic document in a state in which the other version of the electronic document is fixed.

13. The information processing system according to claim 12, wherein the processor is configured to:
in response to the input operation by the user, perform a control of changing a plurality of past versions as the one version of the electronic document according to a value indicating each of the past versions, in a state in which a current version as the other version of the electronic document is fixed.

14. A non-transitory computer readable medium storing a program causing a computer to realize:
a function of managing feature information on each feature of one or more objects included in an electronic document consisting of a plurality of pages, for each version of the electronic document;
a function of extracting a difference in the feature information between versions of the electronic document; and
a function of performing, in a case where a user performs an input operation on an image representing the electronic document displayed on a display unit, a control of displaying the difference on the display unit in a mode identifiable by the user.

15. An information processing method comprising:
managing feature information on each feature of one or more objects included in an electronic document consisting of a plurality of pages, for each version of the electronic document;
extracting a difference in the feature information between versions of the electronic document; and
performing, in a case where a user performs an input operation on an image representing the electronic document displayed on a display unit, a control of displaying the difference on the display unit in a mode identifiable by the user.
